(19) United States
(12) Patent Application Publication
(10) Pub. No.: US 2010/0159228 A1
(43) Pub. Date: Jun. 24, 2010

(54) Method for Preparing a Composite Material

(75) Inventor: ROBERT SMITH, ACCRINGTON (GB)

Correspondence Address: CLARK & ELBING LLP, 101 FEDERAL STREET, BOSTON, MA, 02110, US

(73) Assignee: ISOTHANE LIMITED, ACCRINGTON (GB)

(21) Appl. No.: 12/643,055

(22) Filed: Dec. 21, 2009

(30) Foreign Application Priority Data
Dec. 23, 2008 (GB) 0823464.3

(51) Int. Cl. B32B 27/40; E04F 13/02; B32B 27/06; C08L 75/08

(52) U.S. Cl. 428/292.1; 156/71; 524/590

(57) ABSTRACT

A method for preparing a composite material comprising:
(i) applying a polyurea system comprising an amine component (A) and an isocyanate component (B) to at least part of a surface of a substrate to form a base coat layer on at least part of the surface of the substrate,
   the amine component (A) comprising:
      5 to 20% by weight of polyetheramine with an average molecular weight of 4800 to 5200 (a1);
      50 to 80% by weight of polyetheramine with an average molecular weight of 1900 to 2100 (a2);
      2 to 10% by weight of diethylene toluene diamine (a3);
      10 to 20% by weight of 4,4′ methylene bis (n-sec-butylaniline) (a4); and
      optionally 1 to 5% by weight pigment (a5),
   the isocyanate component (B) comprising 2,4- and 4,4′-methylenediphenyl diisocyanate prepolymer;
(ii) applying a fabric over at least part of the base coat layer and allowing the fabric to bond to the base coat layer;
(iii) applying a polyurethane/polyurea spray foam over at least part of the fabric to form a foam layer; and
(iv) optionally applying a polyurethane/polyurea spray elastomer over at least part of the foam layer to form an elastomer layer.

### CROSS-REFERENCE TO RELATED APPLICATIONS

This application claims priority under 35 U.S.C. 119 from UK application 0823464.3, filed Dec. 23, 2008, the contents of which are incorporated herein by reference.

### FIELD OF THE INVENTION

The present invention relates to a method for preparing a composite material, a novel polyurea system, a base coat and use of the novel polyurea system to bond a fabric to a substrate.

### BACKGROUND OF THE INVENTION

The security of shipping containers and protection of their cargo against theft is of major concern worldwide. High value goods such as pharmaceuticals, chemicals and military equipment that are in transit via barge, rail or road or are at storage depots are particularly vulnerable. Many security solutions for protecting container doors are in operation with various levels of integrity, although it may not be immediately obvious that a break in has occurred and the contents disturbed. Whilst the doors are generally considered to be the most vulnerable part, breaches also occur through the sides, top and bottom of containers using drills, grinders and other cutting equipment.

U.S. Pat. No. 7,098,444 describes lining containers with a liner sheet with an optical path, such as a fabric with optical fibres. Changes in the optical characteristics of the path may be used to detect if the container is breached.

In such a container, damage can occur to the liner sheet, since it is necessary for forklift trucks to operate inside the containers to load and unload cargo. Further, numerous crane lifts and ship and trailer loadings will take place during the life of the container. It is therefore desirable to protect the integrity of the lining and importantly the optical fibres.

An adhesive layer used to bond a fabric liner to a container wall must have sufficient strength and integrity to adhere the fabric. It is also desirable that the adhesive layer has sufficient elastomeric properties to provide a barrier to differential movement forces and thermal expansion between the wall of the container and the fabric, which could over time could cause damage to the circuitry.

Polyurea systems are known in the art for the production of two-component spray-applied seamless coatings. Polyurea systems comprise an isocyanate component and a polyamine component, which are preblended to produce the physical properties required for particular applications. Polyurea systems are known for their rapid curing characteristics, typically 2 to 5 seconds, which is useful when applying protective coatings in cold, damp conditions. The very rapid curing characteristics of polyurea sprays mean that there is not generally sufficient time to accurately position and apply a fabric for its successful bonding to a substrate.

There is therefore a need for new slow gelling polyurea systems that can successfully bond a fabric to a substrate and protect the fabric from subsequent damage.

### SUMMARY OF THE INVENTION

The inventors have discovered a novel slow gelling polyurea system, which surprisingly has the strength and integrity to adhere a fabric to a substrate whilst also allowing sufficient time to accurately position and apply the fabric.

Thus, the present invention relates to a method for preparing a composite material comprising:

(i) applying a polyurea system comprising an amine component (A) and an isocyanate component (B) to at least part of a surface of a substrate to form a base coat layer on at least part of the surface of the substrate,
the amine component (A) comprising:
   5 to 20% by weight of polyetheramine with an average molecular weight of 4800 to 5200 (a1);
   50 to 80% by weight of polyetheramine with an average molecular weight of 1900 to 2100 (a2);
   2 to 10% by weight of diethylene toluene diamine (a3);
   to 20% by weight of 4,4′ methylene his (n-sec-butylaniline) (a4); and
   optionally 1 to 5% by weight pigment (a5),
the isocyanate component (B) comprising 2,4- and 4,4′-methylenediphenyl diisocyanate prepolymer;
   (ii) applying a fabric over at least part of the base coat layer and allowing the fabric to bond to the base coat layer;
   (iii) applying a polyurethane/polyurea spray foam over at least part of the fabric to form a foam layer; and
   (iv) optionally applying a polyurethane/polyurea spray elastomer over at least part of the foam layer to form an elastomer layer.

The steps (i) to (iv) are preferably carried out in the order listed, although other orders are envisaged. For example, the fabric could be coated with the base coat layer and/or with the spray foam layer (and optionally the spray elastomer layer), and the thus coated fabric applied to the substrate.

Additional steps may be carried out, for example the provision of additional layers between the components referred to above.

The present invention further relates to a composite material obtainable by the method of the invention as defined above.

The present invention further relates to a polyurea system comprising an amine component (A) as defined above and an isocyanate component (B) as defined above.

The present invention further relates to a base coat layer obtainable by applying a polyurea system as defined above to at least part of a surface of a substrate.

The present invention further relates to use of a polyurea system as defined above to bond a fabric to a substrate.

### DETAILED DESCRIPTION OF THE INVENTION

As used herein, a substrate can be any material that it is desirable to bond a fabric to. A substrate typically comprises one or more materials selected from a metal, an alloy, a synthetic polymer or a natural product such as a natural polymer. Preferably the substrate comprises a metal or an alloy. Preferred metals are iron and aluminium. A preferred alloy is steel. The substrate is typically a wall of a container, preferably a transport container, and more preferably a shipping container, a rail container or an airfreight container. The walls of such containers are typically corrugated and preferably comprise corrugated steel. Alternatively, the substrate is typically a wall or external face of any structure for which it is desirable to detect breaches or breakages. Preferably said structure is a storage building, a high security building, a warehouse, a secure facility, a gas pipeline, a water pipe or an oil pipeline. Alternatively, said structure typically stores money, for example a ticket machine, a vending machine or an ATM.

As used herein, a fabric is any material that it is desirable to bond to a substrate. Preferably the fabric comprises one or more of delicate fibres, conductive paths, electrical components or optical paths. Conductive paths are preferably provided by metal wires, with copper wires more preferred. Optical paths are preferably provided by optical fibres. In an embodiment the fabric comprises copper wires. In another embodiment the fabric comprises optical fibres. In a further embodiment, the fabric comprises both copper wires and optical fibres. Thus, in a further embodiment, the fabric is a smart textile.

The fabrics of the invention are typically manufactured by weaving techniques, with copper wires and/or optical fibres introduced at regular intervals during the weaving process. Thus, the fabrics of the invention preferably have copper wires and/or optical fibres forming a periodic network across the fabric. The distance between adjacent copper wires and/or optical fibres is typically less than 100 mm, preferably less than 50 mm, more preferably less than 10 mm and most preferably less than 6 mm.

In the first step of the method of the present invention, a polyurea system comprising an amine component (A) and an isocyanate component (B) is applied to at least part of a surface of a substrate to form a base coat layer on at least part of the surface. The base coat layer is typically applied as a continuous or a substantially continuous layer over a surface of a substrate. The base coat layer preferably covers greater than 75% by area of a surface of a substrate, more preferably greater than 85% by area, and most preferably greater than 95% by area. It is yet more preferable if the base coat covers greater than 99% by area of the substrate.

The amine component (A) comprises 5 to 20% by weight of a polyetheramine with an average molecular weight of 4800 to 5200 (a1). Preferably the amine component (A) comprises 10 to 20% by weight of the polyether amine (a1), more preferably 7 to 12% by weight of the polyether amine (a1). Preferably said polyetheramine (a1) has an average molecular weight of 4900 to 5100.

Said polyetheramine (a1) is typically trifunctional. Said polyetheramine (a1) is preferably a compound of formula (I);

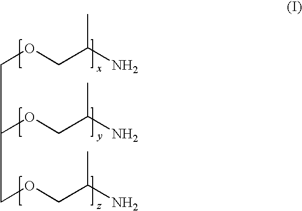

wherein the mean average sum of x, y and z is from 84 to 86. The skilled person will appreciate that such a polyetheramine (a1) will contain molecules for which the sum of x, y and z will not fall in the range 84 to 86, but the mean average sum of x, y and z will preferably fall within that range. Preferably the mean average sum of x, y and z is from 84.5 to 85.5, more preferably 84.8 to 85.2, for example about 85. The average molecular weight of such a polyetheramine (a1) is typically from 4950 to 5050, preferably from 4975 to 5025 and is more preferably about 5000. Suitable polyetheramines (a1) are commercially available from a number of suppliers.

The amine component (A) comprises 50 to 80% by weight of a polyetheramine with to an average molecular weight of 1900 to 2100 (a2). Said amine component (A) preferably comprises 50 to 78% by weight of polyetheramine (a2), more preferably 65 to 75% by weight of polyetheramine (a2).

Said polyetheramine (a2) is typically difunctional. Said polyetheramine (a2) is preferably a compound of formula (II):

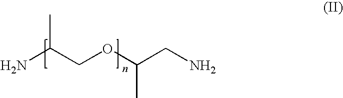

wherein the mean average value of n is from 32 to 34. The skilled person will appreciate that such a polyetheramine (a2) will contain molecules for which the value of n does not fall in the range 32 to 34, but the mean average value of n will preferably fall within that range. Preferably the mean average value of n is 32.5 to 33.5, more preferably 32.8 to 33.2, for example about 33. The average molecular weight of such a polyetheramine (a2) is typically from 1950 to 2050, preferably from 1975 to 2025 and is more preferably about 2000. Suitable polyetheramines (a2) are commercially available from a number of suppliers.

The amine component (A) comprises 2 to 10% by weight of diethylene toluene diamine (a3). Preferably, the amine component (A) comprises 4 to 8% by weight of diethylene toluene diamine (a3). As the skilled person will appreciate, diethylene toluene diamine (a3) can exist as a number of positional isomers. The diethylene toluene diamine (a3) of the present invention can comprise any single positional isomer of diethylene toluene diamine or mixture of positional isomers of diethylene toluene diamine. Commercially available diethylene toluene diamine (TDA) consists of a mixture of positional isomers. A non-limiting example of an isomer of diethylene toluene diamine isomer is 3,5-diethylene toluene 2,4-diamine of formula (III):

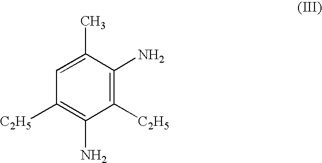

The amine component (A) comprises 10 to 20% by weight of 4,4′ methylene bis (n-sec-butylaniline) (a4) of the following formula (IV):

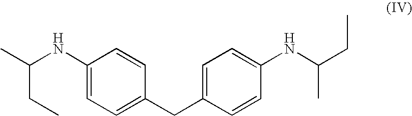

Preferably, the amine component (A) comprises 12 to 18% by weight of 4,4′ methylene bis (n-sec-butylaniline) (a4).

The amine component A optionally comprises 1 to 5% by weight of a pigment (a5), preferably a black pigment, for example carbon black.

Preferably the amine component A comprises: 10 to 20% by weight of polyetheramine (a1); 50 to 78% by weight of polyetheramine (a2); 2 to 10% by weight of diethylene toluene (a3); 10 to 20% by weight of 4,4′ methylene bis (n-sec-butylaniline) (a4); and optionally 1 to 5% by weight of pigment (a5).

More preferably the amine component A comprises: 7 to 12% by weight of polyetheramine (a1); 65 to 75% by weight of polyetheramine (a2); 4 to 8% by weight of diethylene toluene (a3); 12 to 18% by weight of 4,4′ methylene bis (n-sec-butylaniline) (a4); and optionally 1 to 5% by weight of pigment (a5).

The amine component A preferably has a viscosity at 25° C. of 500 to 900 cps, more preferably 600 to 800 cps. The amine component A preferably has a specific gravity at 25° C. of 0.8 to 1.3, more preferably 1.0 to 1.1.

The isocyanate component (B) comprises 2,4- and 4,4′-methylenediphenyl diisocyanate prepolymer.

The 2,4- and 4,4′-methylenediphenyl prepolymer typically has an isocyanate content of 8 to 12, preferably 9 to 11, and more preferably 9.7 to 10.7.

The 2,4- and 4,4′-methylenediphenyl prepolymer is preferably a low functionality prepolymer. Thus, the average functionality of the 2,4- and 4,4′-methylenediphenyl prepolymer is typically 2.0 to 2.5, preferably 2.0 to 2.3, more preferably 2.0 to 2.1, and for example about 2.

Preferably, the 2,4- and 4,4′-methylenediphenyl prepolymer has an isocyanate content of 9 to 11 and an average functionality of 2.0 to 2.3. More preferably, the 2,4- and 4,4′-methylenediphenyl prepolymer has an isocyanate content of 9.7 to 10.7 and an average functionality of 2.0 to 2.1.

The 2,4- and 4,4′-methylenediphenyl prepolymer typically has a viscosity of from 1600 to 2000 mPas·s, preferably from 1700 to 1900 mPas·s, for example about 1800 mPas·s.

The term prepolymer is well known to those skilled in the art, and typically refers to a polymer of relatively low molecular weight that is intermediate between a monomer and a final polymer or resin. Typically the 2,4- and 4,4′-methylenediphenyl prepolymer is a 2,4- and 4,4′-methylenediphenyl quasiprepolymer.

Any suitable method known in the art may be used to apply the polyurea system of the invention to a surface of a substrate. The preferred technique will depend on the size of the substrate. Spray applying is a preferred method, typically from a commercially-available spray gun. If spray applying is used, the dispensing pressure is preferably 500 to 5000 psi, more preferably 1000 to 3500 psi and most preferably 2000 to 3000 psi. If spray applying is used, the temperature is preferably 40 to 80° C., for example 60° C. However, for some smaller substrates such as ticket machines, low-pressure spraying devices are preferred.

The polyurea system of the invention is preferably applied at a thickness 0.2 to 5 litre/m², more preferably 0.5 to 2 litre/m² and most preferably 0.8 to 1.2 litre/m². The mix ratio of the amine component (A) to the isocyanate component (B) is preferably in the range 0.8:1.2 to 1.2 to 0.8 by volume, more preferably 0.9:1.1 to 1.1 to 0.9 by volume, and most preferably 0.95:1.05 to 1.05:0.95 by volume. In an embodiment, the mix ratio of the amine component (A) to the isocyanate component (B) is 1:1 by volume or about 1:1 by volume.

It is important that the base coat layer has a long open time, maintaining tack for long enough to allow the application of a fabric and providing the adhesive properties necessary to bond the fabric to the substrate in the correct or desired orientation. The base coat layer maintains tack while it is still a gel. Thus, the gel time of the base coat layer is preferably 10 to 40 minutes, more preferably 15 to 25 minutes, for example about 20 minutes. The term gel time is well known to those skilled in the art, and is the time that it takes after application of a layer for that layer to cease exhibiting any liquid-like characteristics. The cure time of the base coat layer is preferably 40 to 80 minutes, more preferably 50 to 70 minutes, for example 60 minutes. The term cure time is well known to those skilled in the art. The gel time and cure time are measured at 20° C. in the present invention.

In addition to the adhesive properties of the base coat layer, the physical properties of this layer are important. Not only does the base coat layer attach the fabric to the walls, but also it preferably provides sufficient hardness and/or elastomeric properties to provide a barrier to differential movement forces and thermal expansion between the substrate and the fabric. For example, differential movement forces and thermal expansion between the steel walls of a container and the copper wire or optical fibres in a fabric may damage the copper wire or optical circuitry over time. Thus, the Shore hardness (A) of the base coat layer is preferably 35 to 55, more preferably 40 to 50. The tensile strength of the base coat layer is preferably 4 to 8 MPa, more preferably 5 to 7 MPa. The elongation at break of the base coat layer is preferably 500 to 900%, more preferably 600 to 800%.

The base coat layer provides an insulating layer and non-conductive layer between the substrate and the fabric. This is particularly important when the substrate is a metallic container and the fabric comprises metal wires, since the insulating base coat layer provides further protection against electrical contact forming between the metals wires and the container.

After the base coat layer has been applied to a surface of a substrate, in a second step of the method of the invention, a fabric is applied over at least part of the base coat layer so that the fabric bonds to the base coat layer. The fabric is applied while the base coat layer is still capable of adhering to the fabric. The time period during which the base coat layer has sufficient adherent properties will therefore depend on the gel time of the base coat. Thus, the fabric is applied to the surface of the base coat layer before the gel time of the base coat layer. For example, if the gel time of a base coat layer is 20 minutes, then the fabric is applied to the base coat layer within 20 minutes of application of the base coat layer to the substrate. Typically, at least part of the basecoat layer is absorbed by the surface of the fabric to provide good adhesion and a strong bond between the fabric and substrate.

If the substrate is corrugated, for example corrugated steel in a container, the present invention typically reduces the amount of air that is trapped between the fabric and the substrate when the fabric is applied to the substrate. It is desirable for there to be as little air as possible trapped between the fabric and the substrate.

Once the fabric layer has been applied to the base coat, in a third step of the method of the invention, a polyurethane/polyurea spray foam is applied over at least part of the fabric to form a foam layer. The foam layer encapsulates the fabric and provides protection against damage during use. Any suitable method known in the art may be used to apply the foam layer. Spray applying is a preferred method, typically from a commercially available spray gun. If the foam layer is spray applied, the dispensing pressure is preferably from 500 to 1500 psi, more preferably from 800 to 1200 psi. If the foam layer is spray applied, the temperature is preferably 40 to 80° C., for example 60° C.

The polyurethane/polyurea spray foam used to form the foam layer can be any standard two component spray foam. Suitable two component polyurethane/polyurea spray foams are known to those skilled in the art. The foam layer typically provides mechanical and/or environmental protection. The foam layer is typically 1 mm to 5 mm thick, preferably 2 mm to 3 mm thick.

The foam layer preferably has a cream time of from 2 to 10 seconds, more preferably from 4 to 8 seconds. The foam layer preferably has a tack free time of from 5 to 20 seconds, more preferably from 10 to 15 seconds. The foam layer preferably has a rise time of from 10 to 30 seconds, more preferably from 16 to 24 seconds. The foam layer preferably has a free rise density of from 140 to 300 kg/m³, more preferably from 200 to 240 kg/m³. The foam layer preferably has a specific gravity of 1.00 to 1.20, more preferably from 1.05 to 1.15, and most preferably from 1.08 to 1.10. The foam layer preferably has a viscosity at 20° C. of 500 to 1000 cps, more preferably 650 to 850 cps.

In an optional fourth step of the method of the invention, a polyurethane/polyurea spray elastomer may be applied over at least part of the foam layer to form an elastomer layer. This elastomer layer may provide additional protection in demanding applications, typically additional protection from mechanical damage. Any suitable method known in the art may be used to apply the elastomer layer. Spray applying is a preferred method, typically from a commercially available spray gun. If spray applying is used, the dispensing pressure is preferably 500 to 5000 psi, more preferably 1000 to 3500 psi and most preferably 2000 to 3000 psi. If spray applying is used, the temperature is preferably 40 to 80° C., for example 60° C.

The polyurethane/polyurea spray elastomer used to form the elastomer layer can be any standard two component spray elastomer. Suitable two component polyurethane/polyurea spray elastomers are known to those skilled in the art. A fast gel and cure time is generally desirable for the elastomer layer. Thus, the gel time of the elastomer layer is preferably from 3 to 7 seconds, more preferably from 4 to 6 seconds. The cure time of the elastomer layer is preferably from 8 to 12 seconds, more preferably from 9 to 11 seconds. The gel time and cure time are measured at 20° C. in the present invention.

It is generally desirable for the elastomer layer to have properties of high tensile strength, elasticity, hardness and abrasion resistance. This is because the elastomer layer typically provides an additional protective layer in the structure. Thus, the Shore hardness (A) of the elastomer layer is preferably 45 to 65, more preferably 50 to 60. The tensile strength of the elastomer layer is preferably 15 to 30 MPa, more preferably 20 to 26 MPa and most preferably 22 to 24 MPa. The elongation at break of the elastomer layer is preferably 300 to 500%, more preferably 350 to 450%. The abrasion resistance (using a Taber H10, 1 kg weight and 1000 revs) of the elastomer layer is preferably 25 to 45 mg loss, more preferably 30 to 40 mg loss.

As used herein, the term composite material refers to a material comprising a substrate, a base coat layer, a fabric, a foam layer, and optionally an elastomer layer as describe above. It is important that there is good intercoat adhesion.

In a preferred embodiment, the substrate is a container and the fabric has an optical and/or conductive path. In such an embodiment, the fabric preferably forms a continuous lining on the inside of the container. For example, if the container is cuboid, the fabric preferably forms a continuous internal lining on all six faces of the container. Any disruption to the optical and/or conductive path is detected by a change in the optical and/or conductive properties, and can thus be used to detect a breach through the surface of the container in a security system. The distance between adjacent optical and/or conductive paths, for example adjacent optical fibres and/or conductive wire, determines the sensitivity of the security system. The smaller the distance between adjacent optical and/or conductive paths, the smaller the breaches that are detectable.

The invention therefore provides real time system for detection of a breach that can either (a) trigger an alarm at the location of the breach, or (b) transmit a signal to a control centre monitoring station.

The polyurea system of the invention can be used to form a base coat layer on any substrate. Such a base coat layer can be used to bond a fabric to a substrate in any application where a strong bond is desirable between a substrate and a fabric.

The following Examples illustrate the invention:

### EXAMPLES

### Amine Component 1

The amine component used was Isothane TuffSet A Resin Black. Isothane TuffSet A Resin Black is a fully formulated liquid mixture containing the following ingredients in Table 1.

TABLE 1

| Component | Content (%) | Type of Material |
|---|---|---|
| Polyetheramine 5000 (a1) | 10 | Amine polyol |
| Polyetheramine 2000 (a2) | 70 | Amine polyol |
| Diethylene Toluene Diamine | 5 | Amine |
| (a3) | | |
| 4,4′ methylene bis (n-sec- | 13 | Amine |
| butylaniline) (a4) | | |
| PU grade Black Pigment (a5) | 2 | Pigment |

Isothane TuffSet A Resin Black is a black liquid with a viscosity at 25° C. of about 700 cps, and a specific gravity at 25° C. of 1.0 to 1.1. The polyetheramine 5000 used was JEFFAMINE Polyetheramine 5000 available from Huntsman Corporation. The polyetheramine 2000 used was JEFFAMINE Polyetheramine 2000 available from Huntsman Corporation.

### Isocyanate Component 1

The isocyanate component used was a mixed 2,4- and 4,4′-methylenediphenyl diisocyanate (MDI) quasiprepolymer available as Suprasec 2008 from Huntsman Corporation.

### Formation of Basecoat Layer

A two component spray elastomer composed of Amine Component 1 and Isocyanate Component 1 was applied to a substrate using a high pressure heated plural component machine (Graco E-XP2) and a spray gun (Fusion AP with AR2929 chamber). The substrate was a corrugated mild steel container. The product was applied at a thickness of approximately 1 litre/m². The dispensing pressure was 2500 psi (17 Mpa) and the temperature was 60° C. The mix ratio of Amine Component 1 and Isocyanate Component 1 was 1:1 by volume.

The properties of the base coat layer are displayed in Table 2.

TABLE 2

| Property | Value for base coat layer |
|---|---|
| Gel time (minutes) | 20 |
| Cure time (minutes) | 60 |
| Shore hardness (A) | 45 (Method ASTM 2240) |
| Tensile strength (Mpa) | 6 (Method DIN D638) |
| Elongation at break (%) | 700 (Method DIN D638) |

### Application of Fabric

A copper wire containing fabric (available from SEFAR AG) was then applied in strips to the base coat layer within 20 minutes (i.e. before the gel time of the base coat layer). This allowed for the complete coverage of the substrate and intimate bonding of the fabric to the surface of the substrate, via the base coat layer.

### Foam Layer

A foam layer was next applied over the fabric. The foam layer used was a standard two component spray foam product, available as TuffSet S from Isothane Ltd. The layer was applied using a Gusmer FF1600 machine and a Gusmer D Gun spray gun. The dispensing pressure was 1000 psi (7 Mpa) and the temperature was 60° C. The mix ratio of resin to isocyanate was 1:1 by volume.

The isocyanate component of TuffSet S was crude 4,4′-methylenediphenyl diisocyanate (MDI) available as Suprasec 5025 from Huntsman Corporation. The amine component was TuffSet S Amine Resin from Isothane Ltd.

The properties of the foam layer are displayed in Table 3.

TABLE 3

| Property | Value for foam layer |
|---|---|
| Cream time (s) | 4 to 8 |
| Tack Free time (s) | 10 to 15 |
| Rise time (s) | 16 to 24 |
| Free rise density (kg/m³) | 200 to 240 |
| Specific gravity | 1.08 to 1.1 |
| Viscosity at 20° C. (cps) | 650 to 850 |

### Elastomer Layer

A standard rapid set two component spray elastomer product available as TuffSet P from Isothane Ltd was applied over the foam layer using a high pressure heated plural component machine (Graco E-XP2) and a spray gun (Fusion AP with AR2929 chamber). The dispensing pressure was 2500 psi (17 Mpa) and the temperature was 60° C. The mix ratio of resin to isocyanate was 1:1 by volume.

The isocyanate component used was 4,4′-methylenediphenyl diisocyanate (MDI) quasiprepolymer available as Suprasec 2054 from Huntsman Corporation. The amine component used was TuffSet P Amine Resin from Isothane Ltd.

The properties of the elastomer layer are displayed in Table 4.

TABLE 4

| Property | Value for elastomer layer |
|---|---|
| Gel time (s) | 5 |
| Cure time (s) | 10 |
| Shore hardness (D) | 55 (Method ASTM 2240) |
| Tensile strength (MPa) | 23 (Method DIN D638) |
| Elongation at break (%) | 400 (Method DIN D638) |
| Abrasion resistance using a Taber H10 | 35 (Method D4060) |
| wheel, 1 kg weight, 1000 revs (mg loss) | |

1. A method for preparing a fabric reinforced composite material comprising:
(i) applying a polyurea system comprising an amine component (A) and an isocyanate component (B) to at least part of a surface of a substrate to form a base coat layer on at least part of the surface of the substrate,
the amine component (A) comprising:
5 to 20% by weight of polyetheramine with an average molecular weight of 4800 to 5200 (a1);
50 to 80% by weight of polyetheramine with an average molecular weight of 1900 to 2100 (a2);
2 to 10% by weight of diethylene toluene diamine (a3);
10 to 20% by weight of 4,4′ methylene bis (n-sec-butylaniline) (a4); and
optionally 1 to 5% by weight pigment (a5),
the isocyanate component (B) comprising 2,4- and 4,4′-methylenediphenyl diisocyanate prepolymer;
(ii) applying a fabric over at least part of the base coat layer and allowing the fabric to bond to the base coat layer;
(iii) applying a polyurethane/polyurea spray foam over at least part of the fabric to form a foam layer; and
(iv) optionally applying a polyurethane/polyurea spray elastomer over at least part of the foam layer to form an elastomer layer.

2. A method according to claim 1, wherein the polyetheramine (a1) is a compound of formula (I): 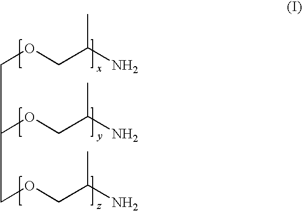
wherein the mean average sum of x, y and z is from 84 to 86.

3. A method according to claim 1, wherein the polyetheramine (a2) is a compound of formula (II): 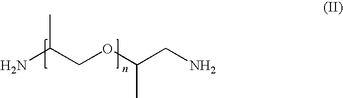
wherein the mean average value of n is from 32 to 34.

4. A method according to claim 1, wherein the 2,4- and 4,4′-methylenediphenyl diisocyanate prepolymer has an isocyanate content of 8 to 12.

5. A method according to claim 1, wherein the 2,4- and 4,4′-methylenediphenyl diisocyanate prepolymer has an average functionality of 2.0 to 2.5.

6. A method according to claim 1, wherein the mix ratio of the amine component (A) to the isocyanate component (B) is in the range 0.8:1.2 to 1.2 to 0.8 by volume.

7. A method according to claim 1, wherein the substrate is a shipping container, rail container or airfreight container.

8. A method according to claim 1, wherein the substrate is a storage building, a high security building, a warehouse, a secure facility, a gas pipeline, a water pipe or an oil pipeline.

9. A method according to claim 1, wherein the fabric comprises one or more of electrical paths, electrical components and optical paths.

10. A composite material obtainable by the method of claim 1.

11. A polyurea system comprising an amine component (A) as defined in claim 1 and an isocyanate component (B) as defined in claim 1.

12. A polyurea system according to claim 11, wherein the mix ratio of the amine component (A) to the isocyanate component (B) is in the range 0.8:1.2 to 1.2 to 0.8 by volume.

13. A base coat layer obtainable by applying a polyurea system according to claim 11 to at least part of a surface of a substrate.

14. A base coat layer according to claim 13 wherein the substrate is a shipping container, a rail container, an airfreight container, a storage building, a high security building, a warehouse, a secure facility, a gas pipeline, a water pipe or an oil pipeline.

15. A method of bonding a fabric to a substrate using a polyurea system as defined in claim 11.

16. A method according to claim 15, wherein the substrate is a shipping container, a rail container, an airfreight container, a storage building, a high security building, a warehouse, a secure facility, a gas pipeline, a water pipe or an oil pipeline.

17. A method according to claim 15, wherein the fabric comprises one or more of electrical paths, electrical components and optical paths.
